(19) United States
(12) Patent Application Publication
(10) Pub. No.: US 2003/0159076 A1
(43) Pub. Date: Aug. 21, 2003

(54) Keyboard controller providing power management for a portable computer system

(75) Inventors: David J. Delisle, Spring, TX (US); William C. Hallowell, Spring, TX (US); Patrick R. Cooper, Houston, TX (US)

Correspondence Address: AKIN, GUMP, STRAUSS, HAUER & FELD, 711 LOUISIANA STREET, SUITE 1900 SOUTH, HOUSTON, TX, 77002, US

(73) Assignee: Compaq Information Technologies Group, L.P., Houston, TX (US)

(21) Appl. No.: 10/291,798

(22) Filed: Nov. 8, 2002

Related U.S. Application Data
(63) Continuation of application No. 08/684,420, filed on Jul. 19, 1996, now abandoned.

(51) Int. Cl. G06F 1/26

(52) U.S. Cl. 713/300

(57) ABSTRACT

A keyboard controller provides power management for a portable computer system. The keyboard controller both receives data from the keyboard and controls powering of a direct current/direct current converter. The keyboard controller may include a means for receiving data from the keyboard, a means for turning on power to the direct current/direct current converter, and a means for turning off the power to the direct current/direct current converter.

### CROSS-REFERENCE TO RELATED APPLICATIONS

This application is a continuation of co-pending U.S. patent application Ser. No. 08/684,420 filed on Jul. 19, 1996, which is incorporated herein in its entirety by reference.

### STATEMENTS REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

1. Field of the Invention

The present invention generally relates to a keyboard controller providing power management for a portable computer system.

2. Description of the Related Art

The growth of the personal computer industry is attributable in part to the availability of small, low cost and powerful computers. Improvements in processor, memory, data storage and battery technologies have resulted in lightweight and powerful mobile computers such as portables, luggables, laptops, notebooks, palmtops. These computers can provide sufficient processing capability for audio/visual applications such as computer-aided design, three-dimensional animation, and multimedia presentation for extended durations, even when users are at relatively inaccessible locations.

Each portable computer typically includes a microprocessor, a memory system, data storage devices, and input/output (I/O) devices such as a display, a keyboard, a mouse, and communication devices such as a modem, among others. To offload the I/O work from the processor, the computer system typically provides one or more specialized controllers to handle the I/O processing. One such specialized I/O system is the keyboard system. The keyboard I/O system typically includes two components: a keyboard and a keyboard interface. The keyboard typically has a keyboard chip which is connected to X and Y decoders, each respectively connected to a scan matrix. The scan matrix is formed by crossing electrically conductive lines where one or more small switches or keys are located. If one key is pressed, the switch is closed to short out the matrix at the intersection of particular X and Y locations. The keyboard chip regularly checks the status of the scan matrix to determine the open or closed state of the switches. For this purpose, it activates successively and individually the X lines and detects from which Y terminals the keyboard chip receives a signal. By means of the X and Y coordinates, the newly pressed or released switch or key can be unambiguously identified. The information detected by the keyboard chip is communicated to the processor over a keyboard cable/connector and a keyboard controller.

Although the keyboard controller could be a simple serial interface without any intelligent processing, more recent computers incorporate an intelligent keyboard interface which is able to do more than simply accept a serial data stream and issue an interrupt to the processor. The keyboard controller is typically a microcontroller pre-programmed to handle keyboard events. The keyboard controller can be programmed, for example, to disable the keyboard. Moreover, a bidirectional data transfer between the keyboard and the keyboard controller is possible. Thus, the keyboard controller can also transfer data to the keyboard interface. The keyboard controller, under software control, is therefore capable of receiving control commands through which the user may, for example, set the repetition rate of the keyboard.

One important system in the portable computer system is a battery power source which provides alternate battery power in addition to the standard alternating current (AC) power source to enable the portable computer system to operate in locations where conventional AC power is not available. Rechargeable batteries are typically used as an alternative source of power. Although historically the power source is simply one or more battery cells, more recent battery power sources have provided on-board intelligence via a microcontroller which tracks available power, recharge status, discharge status, and battery insertion among others. To take advantage of the information provided by the microcontroller on the battery packs, a battery monitoring circuit on the portable computer system needs to periodically poll the batteries.

Although the processor can perform the polls to manage events relating to the battery insertion/removal process, the power on process, the stand-by process, and the laptop/palmtop lid opening/closing detection process, pushing such functionality into the processor is disadvantageous, as the processor has to be powered on to handle these events.

One solution to the battery management process deploys a second microcontroller for handling battery and power/standby button related functions. The battery microcontroller typically monitors the voltage of the battery cells and also provides fuel gauging. Fuel gauging is a process of determining how much useful charge remains in the battery, and is typically accomplished by Coulomb counting. Additionally, rechargeable batteries have a limited cycle life, and discharge cycle time is usually measured in hours, not days. To solve this issue, vendors have begun to incorporate multiple battery packs in portable computer systems. The use of multiple battery backs enables the user to remain in the mobile environment for longer periods of time. Multiple battery packs also provide a certain amount of power supply redundancy. However, the use of multiple battery packs also requires the battery microcontroller to detect the insertion and removal of batteries and to appropriately update the data related to the battery packs. Further, the use of multiple battery packs can cause problems where, in the event that two or more battery packs are concurrently active, differences in charge levels between the packs can cause current to flow from one battery pack to another. Thus, the battery microcontroller also must arbitrate between the particular battery pack to operate as a master battery pack.

The battery microcontroller is typically powered on all the time as it needs to detect battery related events regardless of whether the computer system is in the respective on, off, or standby states. As a result, the battery microcontroller is typically an ultra low-power 4-bit microcontroller. When the computer enters a power-off, stand-by or idle mode, power is removed from a significant portion of the portable computer system to conserve power. Further, to conserve power during standby or turnoff periods, the microcontroller typically has a powerdown mode where its power consumption is minimized. Nonetheless, power to the battery microcontroller is maintained so that battery insertions/removals, lid openings/closures and power-on/standby button actuations can still be detected. The battery microcontroller is waken during battery insertion, battery removal, computer lid opening and closure, and activation of the power and the standby pushbuttons. After handling the wakeup events, the battery microcontroller is typically idled or powered down to conserve power. Along the same line, the keyboard microcontroller is typically turned off during the periods of non-use to conserve battery consumption. Upon detection of keyboard events, the microcontroller performing the keyboard function is waken to accept keyboard inputs. Further, to conserve power consumption during periods of non-use, the keyboard microcontroller is powered-off in these periods.

As discussed above, the use of separate microcontrollers for keyboard function and for battery/button control function injects undesirable cost, component real estate, and power consumption issues to adversely impact the attributes of the portable computer. The use of multiple microcontrollers leads to potential losses in the power control process, as multiple microcontrollers consume extra power, even when they are idled. Further, the manufacturing cost is increased, as multiple microcontrollers need to be placed and soldered. Further, the use of multiple components raises the risk of system failure caused by the failure potentials of the additional components. Cost, size and power consumption are areas of particular concern in the portable computer market.

### SUMMARY OF THE INVENTION

A keyboard controller provides power management for a portable computer system. The keyboard controller both receives data from the keyboard and controls powering of a direct current/direct current converter. The keyboard controller may include a means for receiving data from the keyboard, a means for turning on power to the direct current/direct current converter, and a means for turning off the power to the direct current/direct current converter.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram of a computer system having a low-power controller combining keyboard control and battery control functions in accordance with the present invention;

FIG. 2 is a schematic block diagram of the low-power controller combining keyboard control and battery control functions of FIG. 1;

FIG. 3 is a flow chart illustrating different power states in the computer system of FIG. 1 and the process for handling these power states in the computer system of FIG. 1;

FIGS. 4A and 4B are flow charts illustrating the process for handling events in an ON state of the process of FIG. 3;

FIGS. 5A, 5B and 5C are flow charts illustrating the process for handling events during an OFF state of the process of FIG. 3;

FIGS. 6A and 6B are flow charts illustrating the process for handling events when the computer system of FIG. 1 is in a STANDBY mode;

FIG. 7 is a flow chart illustrating the process of handling battery events per each second in the computer system of FIG. 1;

FIG. 8 is a flow chart illustrating the process for handling battery events per each millisecond in the computer system of FIG. 1;

FIG. 9 is schematic diagram of the state machine for handling battery events per each millisecond in the computer system of FIG. 1;

FIG. 10 is a flow chart illustrating the process for handling events in STATE0 of FIG. 7.

FIG. 11 is a flow chart illustrating the process for handling events in STATE1 of FIG. 7.

FIG. 12 is a flow chart illustrating the process for handling events in STATE2 of FIG. 7;

FIG. 13 is a flow chart illustrating the process for handling events in STATE3 of FIG. 7.

FIG. 14 is a flow chart illustrating the process for handling events in STATE4 of FIG. 7.

FIG. 15 is a flow chart illustrating the process for handling events in STATE5 of FIG. 7.

FIG. 16 is a flow chart illustrating the process for handling events in STATE6 of FIG. 7; and

FIG. 17 is a flow chart illustrating the process for handling events in STATE7 of FIG. 7.

### DETAILED DESCRIPTION OF THE PREFERRED EMBODIMENT

The following disclosures are hereby incorporated by reference:

U.S. application Ser. No. 08/684,686, entitled “IMPROVED CONTROL OF COMPUTER AC ADAPTER OUTPUT VOLTAGE VIA BATTERY PACK FEEDBACK,” by Brian C. Fritz, William C. Hallowell, Thomas P. Sawyers, Norman D. Stobert, Robert F. Watts and Michael E. Schneider, filed concurrently herewith;

U.S. application Ser. No. 08/684,414, entitled “FLASH ROM SHARING,” by Hung Q. Le and David J. Delisle, filed concurrently herewith;

U.S. application Ser. No. 08/684,413, entitled “FLASH ROM PROGRAMMING” by Hung Q. Le, Patrick R. Cooper and David J. Delisle, filed concurrently herewith;

U.S. application Ser. No. 08/684,486, entitled “BUS SYSTEM FOR SHADOWING REGISTERS,” by Dwight D. Riley and David J. Maguire, filed concurrently herewith;

U.S. application Ser. No. 08/684,412, entitled “CIRCUIT FOR HANDLING DISTRIBUTED ARBITRATION IN A COMPUTER SYSTEM HAVING MULTIPLE ARBITERS,” by David J. Maguire, Dwight D. Riley and James R. Edwards, filed concurrently herewith;

U.S. application Ser. No. 08/684,485, entitled “LONG LATENCY INTERRUPT HANDLING AND INPUT/OUTPUT WHILE POSTING,” by David J. Maguire and James R. Edwards, filed concurrently herewith;

U.S. application Ser. No. 08/684,710, entitled “SERIAL BUS SYSTEM FOR SHADOWING REGISTERS,” by David J. Maguire and Hung Q. Le, filed concurrently herewith;

U.S. application Ser. No. 08/684,584, entitled “APPARATUS AND METHOD FOR POSITIVELY AND SUBTRACTIVELY DECODING ADDRESSES ON A BUS,” by Gregory N. Santos, James R. Edwards, Dwight D. Riley and David J. Maguire, filed concurrently herewith;

U.S. application Ser. No. 08/684,316, entitled “TWO ISA BUS CONCEPT,” by Gregory N. Santos, James R Edwards, Dwight D. Riley and David J. Maguire, filed concurrently herewith;

U.S. application Ser. No. 08/684,490, entitled “RECONFIGURABLE DUAL MASTER IDE INTERFACE,” by Gregory N. Santos, David J. Maguire, William C. Hallowell and James R. Edwards, filed concurrently herewith; and

U.S. application Ser. No. 08/684,255, entitled “COMPUTER SYSTEM INCORPORATING HOT DOCKING AND UNDOCKING CAPABILITIES WITHOUT REQUIRING A STANDBY OR SUSPEND MODE,” by Richard S. Lin, David J. Maguire, James R. Edwards and David J. Delisle, filed concurrently herewith; all of which are assigned to the assignee of this invention.

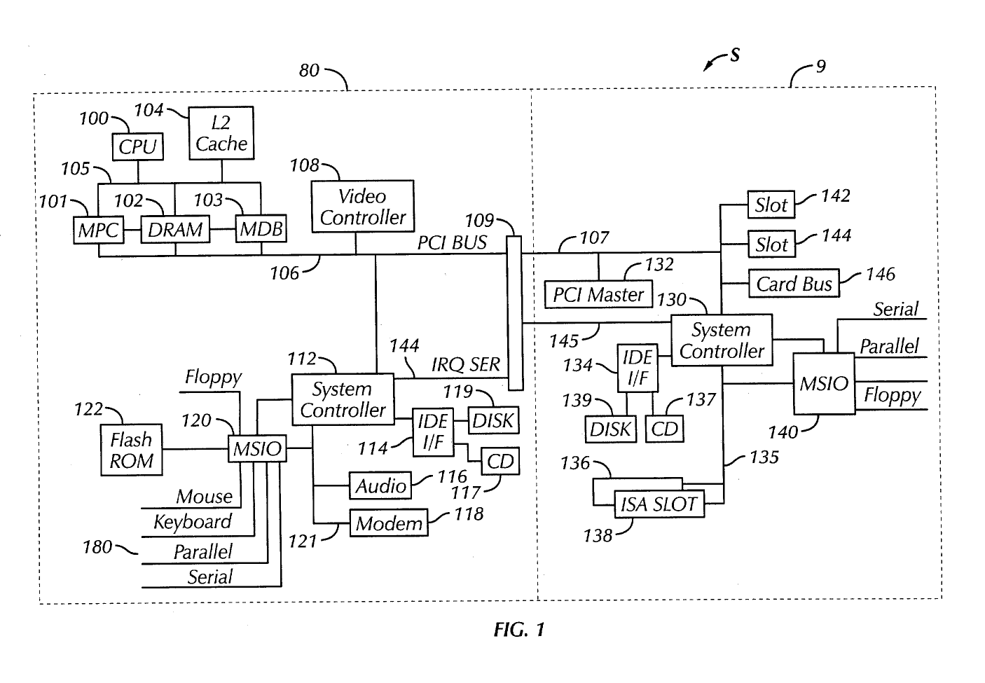

Turning now to the drawings, FIG. 1 is a computer system S according to the present invention. In FIG. 1, the system S comprises a portable computer 80 and an expansion base unit 90. Within the portable computer 80, a CPU 100 and a level two (L2) cache 104 are connected to a high speed local bus 105. The processor 100 of the preferred embodiment is one of the 80×86 microprocessor family manufactured by Intel Corporation of Santa Clara, Calif. In the preferred embodiment, the processor operates with a standard IBM-PC compatible operating system, such as MS-DOS or Windows, available from Microsoft Corporation of Redmond, Wash. The L2 cache 104 provides additional caching capabilities to the processor's on-chip cache to improve performance.

In addition to the CPU 100 and cache 104, a number of memory interface and memory devices are connected between the local bus 105 and a PCI bus 106. These devices include a memory to PCI cache controller (MPC) 101, a dynamic random access memory (DRAM) array 102, and a memory data buffer (MDB) 103. The MPC 101 is connected to the DRAM array 102, which is further connected to the MDB 103. The MPC 101, DRAM array 102, and MDB 103 collectively form a high performance memory system for the computer system S. A video controller 108 is also connected to a PCI bus 106.

The PCI bus 106 is also connected to a system controller 112. The system controller 112 is a PCI to ISA bus bridge which also provides various support functions distributed between the portable computer 80 and the expansion base unit 90 of the system S. Preferably the system controller 112 is a single integrated circuit that acts as a PCI bus master and slave, an ISA bus controller, an ISA write posting buffer, an ISA bus arbiter, DMA devices, and an IDE disk interface. The system controller 112 is connected to an audio controller 116 and a modem 118 as conventionally present in I²C systems to provide sound and data communication capabilities for the system S via a first ISA interface 121. The system controller 112 is also connected to an IDE interface port 114 for driving one or more peripheral devices such as hard disk drives, preferably a CD-ROM player 117 and a disk drive 119. The peripheral devices such as the disk drives typically store boot data used during the initial power up of the computer system. Further, the system controller 112 provides a single pin output to support a interrupt serial bus (IRQSER) 144.

The system controller 112 is connected to an MSIO (mobile super 110) chip 120. The MSIO 120 is connected to a flash ROM 122. The flash ROM 122 receives its control, address and data signals from the MSIO 120. Preferably, the flash ROM 122 contains the BIOS information for the computer system S and can be reprogrammed to allow for revisions of the BIOS. Additionally, the MSIO 120 provides a parallel port 180, a serial port, a keyboard interface and a mouse interface, among others, for the computer system S.

A plurality of Quick Connect switches 109 are also connected to the PCI bus 106. Upon detecting a docking sequence between the portable computer 80 and the base unit 90, the Quick Connect switches 109 couple the PCI bus 106 and the IRQSER bus 144 to an expansion PCI bus 107 and an expansion IRQSER bus 145 on the base unit 90. The Quick Connect switches 109 are series in-line FET transistors having low r_{ds}, or turn-on resistance, values to minimize the loading on the PCI buses 106 and 107 and the LRQSER buses 144 and 145.

Turning now to the expansion base unit 90, one or more PCI masters 132 are connected on the expansion PCI bus 107, which is adapted to be connected to the PCI bus 106 over the Quick Switches 109 when the portable computer 80 is docked to the expansion base unit 90. The PCI bus 107 is also connected to PCI slots 142 and 144 and also to a card bus interface 146 for accepting expansion cards. Also connected to the expansion PCI bus 107 is a second system controller 130, which is preferably a second integrated circuit of the same type as the system controller 112. The system controller 130 is configured to be the slave upon power up. As a slave, the write posting buffer is not available in the system controller 130. The system controller 130 is connected to the expansion PCI bus 107 and the interrupt serial bus 145. The system controller 130 supports additional drives 137 and 139 through an the IDE interface 134. The system controller 130 also supports an ISA bus 135 which is connected to one or more ISA slots 136-138. The system controller 130 is further connected to a second MSIO device 140, which provides a secondary parallel port, serial port, and floppy interface.

Thus, the system S, upon docking, may have multiple parallel ports, serial ports, keyboards, mice, and disk drives via the system controllers 112 and 130. Additionally, the system S may have a plurality of PCI and ISA type peripherals on their respective buses. The availability of a plurality of slots allows more peripherals to be connected to the system S and contributes to the usability and flexibility of the portable computer 80 when it is docked to the expansion base unit 90.

The expansion base unit 90 is typically powered using AC power. Thus, the power source on the expansion base unit 90 is a traditional power supply with a disable input to place the power supply into a low power mode so as to be compliant with the “Green PC” guidelines issued by the U.S. Energy Department. The portable computer 80, on the other hand, faces a number of challenges in managing its power sources. In the portable computer, three power planes exist: a VCC0 plane which is connected to a coin cell (not shown). The VCC0 plane is connected to the power inputs of a sensitive electronics such as the volatile RAMs and the real time clock. The VCC0 plane is intended to supply backup voltage supply to devices when they are in a powered down mode with very little current consumption so that even the coin cell could last a reasonably long time. The portable computer, 80 also has a VCC1 plane which principally provides power to the 8051 microcontroller 174. Finally, the portable computer 80 has a VCC2 plane with 5V and 12V carriers to provide power to the portable computer 80 when the user places the portable computer 80 in an ON state or a STANDBY state.

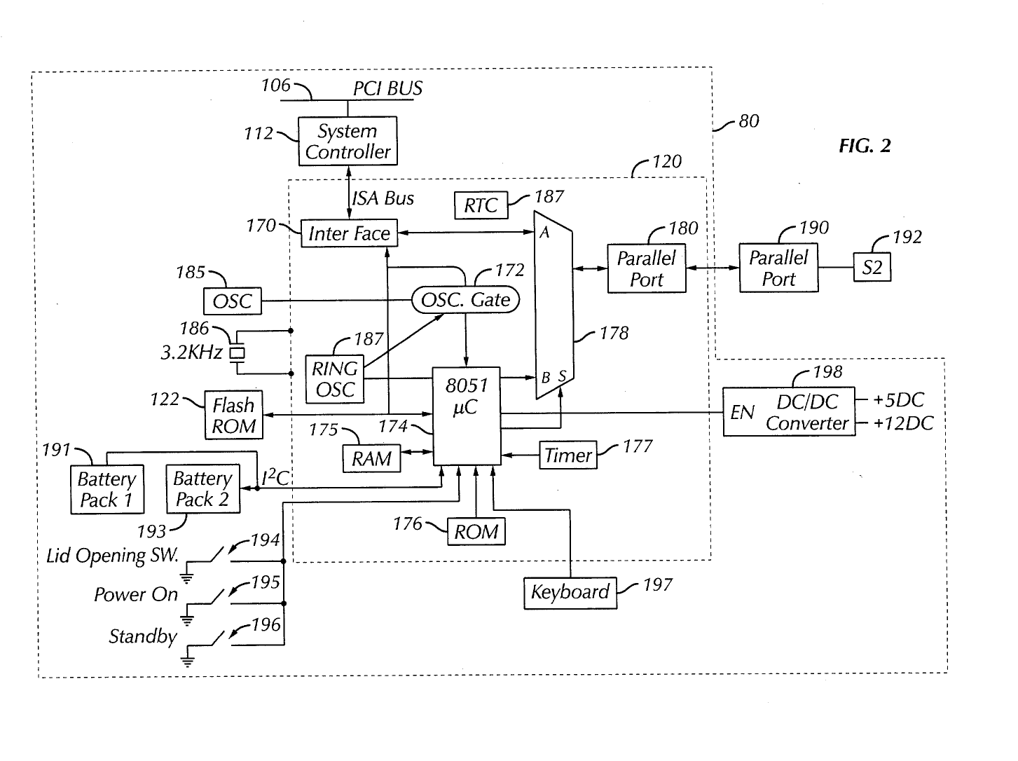

Turning to FIG. 2, the circuitry for sharing the flash ROM 122 between a microcontroller and a microprocessor is disclosed. In FIG. 2, operations directed at the ISA expansion bus are communicated over the PCI bus 106 and directed at the system controller 112. The system controller 112 communicates with the super 110 device 120 over the ISA bus. In the super 110 device 120, an interface unit 170 is connected to the ISA bus for receiving instructions from the CPU 100. The interface 170 provides a number of “mailbox” registers mapped into the 110 memory space to facilitate the interprocessor communication and coordination between the CPU 100 and a microcontroller 174. The interface 170 is connected to the enable input of an oscillator gating circuit 172 to allow the CPU 100 to control the generation of the clock to the microcontroller 174. The oscillator gating circuit, or the variable clock generator 172 receives a clock signal which is externally generated by an oscillator 185. The oscillator gating circuit or variable clock generator 172 preferably receives a 14 MHz clock signal from the oscillator 185 and generates a programmable clock output that can be selected from 0 MHz, 12 MHz, 14 MHz, or 16 MHz. The oscillator 185 is active when the computer system 80 is in the ON state.

Further, an external 32 KHz oscillator 186 provides clocking signals to a variety of components when the MSIO 120 is in a reduced power mode. It is used in part to provide a known clock to a real time clock (RTC) circuit 189.

The deep sleep mode is an ultra low power mode where most sections of the microcontroller 174 are shut down to conserve power. This mode is a special mode that is provided as an enhancement to a standard 8051-compatible microcontroller cell. The deep sleep mode is entered when the standard 8051 IDLE instruction is executed with a particular register bit set. In this mode, the microcontroller 174 assumes that it will operate off a ring oscillator 187 and thus arms the ring oscillator 187 such that the ring oscillator 187 will wake up when certain events such as interrupts are presented to the microcontroller 174.

As discussed above, the internal ring oscillator 187 is connected to the oscillator gating circuit 172 to provide clock signals to the microcontroller 174 when the computer system 80 is in the STANDBY mode or when the microcontroller comes out of its deep sleep. The ring oscillator 187 is simply an on chip oscillator that operates between 4 and 20 MHz-its frequency is not critical. The external events that wake up the microcontroller 174 include the actuation of the ring indicator from the modem, the standby button, the hibernation button, PCMCIA card detect, and the PCMCIA ring indicator. The internal events which wake up the microcontroller 174 include events relating to the real time clock alarm, the hibernation time, and the keyboard matrix, among others. Finally, the output of the oscillator gating circuit 172 is provided to the clock input of the 8051 compatible microcontroller 174.

Other than the special clock circuits discussed above for the deep sleep feature, the 8051 compatible microcontroller 174 has a random access memory (RAM) 175 and a read only memory (ROM) 176 for storing boot-up instructions. The microcontroller 174 has a built-in timer 177 named Timer₁₃ 0 which may be used to allow the microcontroller 174 to detect failures when the timer time-outs. The timer 177 is a count-up timer which interrupts at the rollover point. The timer 177's duration and count-up sequencing are controlled by the microcontroller 174. The timer 177 generates an interrupt to the microcontroller 174 upon the completion of its count sequence. The generation of the interrupt to the microcontroller 174 wakes the microcontroller 174 out of its idle mode so that the processing of the routines of the present invention can be performed. The timer 177 is used as a fail-safe mechanism to wake up the microcontroller in the event of power failures and other abnormal operating conditions.

Although a conventional timer can be used, the present invention also contemplates that 30 a watchdog timer can be used in place of the timer 177. In the event that the watchdog timer is used, the software overhead on the microcontroller 174 is reduced, as the watchdog timer will reset the microcontroller 174 in event of an abnormal program execution. If the watchdog timer is not periodically reset by the microcontroller 174, the counter in the watchdog timer overflows, causing the microcontroller 174 to be reset. The watchdog timer thus restarts the microcontroller 174 in abnormal situations, providing for recovery from a hardware or software error.

The microcontroller 174 is also connected to the select input of a two-to-one multiplexer 178. The B input of the multiplexer 178 is connected the input/output lines of the microcontroller 174. The A input of the multiplexer 178 is connected to the interface 170 for transferring data from the parallel port directly to the processor 100 via the system controller 112. The microcontroller 174 has an output connected to the select input S of the multiplexer 178 to control the routing of data from the parallel port 180 to either the interface 170 or the microcontroller 174. The output of the multiplexer 178 is connected to the parallel port 180. The interface 170 and the microcontroller core 174 are connected to the flash ROM 122. Finally, the parallel port 180 communicates with a parallel port 190 (FIG. 2) which is driven by a second computer system 192. The second computer system 192 contains uncorrupted data such as a new valid BIOS to be loaded to the flash ROM 122.

Additionally, the microcontroller 174 of FIG. 2 receives battery statistics from one or more battery packs 191 and 193 over an inter-integrated circuit (I²C) bus. The inter-integrated circuit (I²C) bus is a simple bi-directional two wire bus for efficiently controlling multiple integrated chips. Details of the I²C bus can be found in the “The I²C-Bus and How to Use It (Including Specification),” published by Phillips Semiconductors, January 1992. Briefly, the I²C bus consists of two lines: a serial clock (SCL) and a serial data line (SDA). Each of these lines is bi-directional. The SCL line provides the clock signal for data transfers which occur over the I²C bus. Logic levels for this signal are referenced to VBATT-, which is common to all installed battery packs B. The SDA line is the data line for data transfers which occur over the I²C bus. Again, logic levels for this signal are referenced to VBATT-. As illustrated by a second installed battery pack 193, the battery microcontroller of any additional battery pack is also coupled to the MSIO 120 via the I²C bus. Low value series resistors (not shown) are typically provided at each device connection for protection against high-voltage spikes.

Each device connected to the I²C bus is recognized by a unique address—whether it is the MSIO 120 or the battery microcontroller of any installed battery packs 191 and 193. Both the MSIO 120 and battery microcontroller incorporate an on-chip interface which allows them to communicate directly with each other via the I²C bus. Using the I²C bus in cooperation with the master battery signal MSTR_BAT reduces the number of interface signals necessary for efficient battery management. Co-pending U.S. patent application Ser. No. 08/573,296, entitled “BATTERY PACK WAKEUP” and filed on Dec. 15, 1995, illustrates various aspects of nickel-based and lithium ion battery packs and communications over a serial bus. This application is hereby incorporated by reference.

Further, the microcontroller 174 also receives inputs from a plurality of switches, including a computer lid opening switch 194, a power on switch 195, and a standby switch 196. The lid opening switch 194 senses when the lid of the computer system 80 is opened, indicating that the user is about to activate the computer system 80. The power on switch 195 allows the user to turn on the portable computer 80, while the standby switch 196 allows the user to put the portable computer system 80 to an idle mode or a sleep mode to conserve power. Preferably, the actuation of the switches 194, 195 and 196 generates an interrupt to the microcontroller 174 and causes the microcontroller 174 to exit its deep sleep mode, if the microcontroller 174 is in such a mode, and further causes the microcontroller 174 to branch to an appropriate interrupt handler to respond to the actuation of the switches or the insertion/removal of the battery packs 191 and 193.

Finally, the microcontroller 174 is connected to a keyboard 197 for receiving data entries from the user. The microcontroller 174 is further connected to a DC/DC converter 198 which provides regulated +5VDC and +12VDC to the VCC2 plane to power the portable computer 80. The DC/DC converter receives a DC voltage supplied by an AC/DC converter (not shown) which is connected to the AC power at a docking station (not shown). When the portable computer unit 80 is docked with its docking station, it communicates with peripheral devices, receives DC currents for charging batteries plugged into the portable computer 80 and for operating the portable computer unit 80. The DC/DC converter 198 has an enable input driven by the microcontroller 174 such that the microcontroller 174 can turn on or off the DC/DC converter 198.

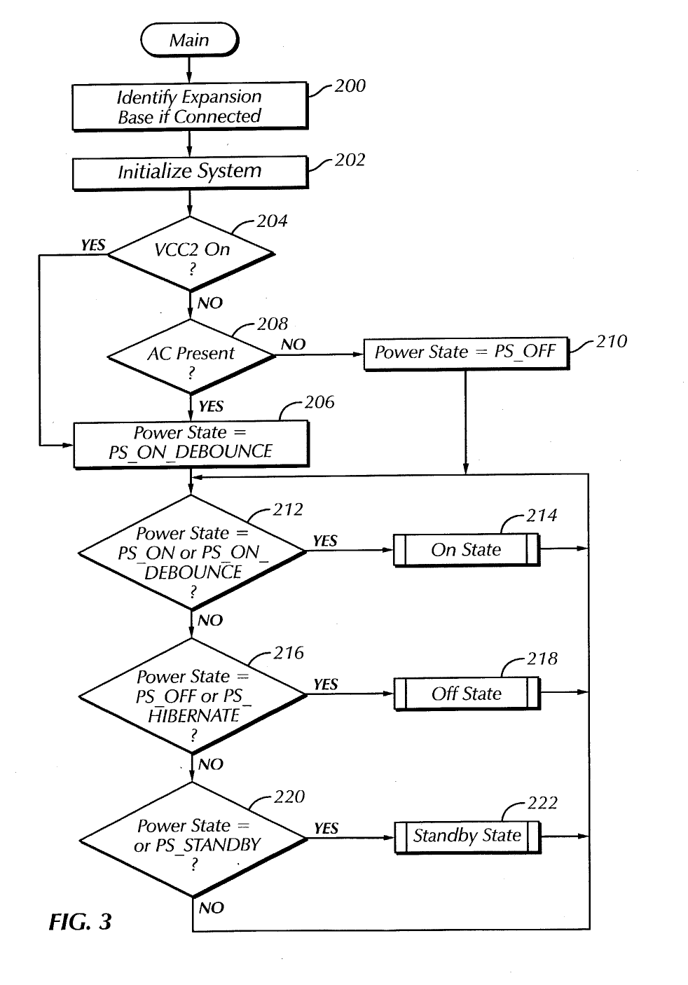

Turning now to FIG. 3, a flow chart showing the operation of the microcontroller 174 for handling the keyboard, battery and power/standby buttons is disclosed. Upon entry to the routine of FIG. 3, the microcontroller 174 determines whether the portable computer 80 is connected to the expansion base unit 90 in step 200. If so, the routine identifies the ID of the expansion base unit 90 in step 200. From step 200, the microcontroller 174 initializes its system, including the initialization of the RAM 175 and various microcontroller 174 1/0 ports in step 202, among others. From step 202, the microcontroller 174 determines whether the second power plane VCC2 has power applied to it in step 204. If power exists on VCC2 in step 204, the routine transitions to step 206 where a power state variable PowerState is assigned with PS_ON_DEBOUNCE to indicate that the user has pressed the power button 195 and that the button 195 needs to be debounced to prevent false switch detections.

Alternatively, from step 204, if VCC2 is not powered on, the routine next determines whether the AC line, into which the portable computer 80 is plugged, is available in step 208 by testing the output of the power converter 198. If so, the routine transitions from step 208 to step 206 where the power state variable PowerState is also assigned to PS_ON_DEBOUNCE. From step 208, if the power converter 198 is inactive, indicating that AC power is not available, the routine transitions to step 210 where PowerState is assigned with PS_OFF to indicate that power is not available.

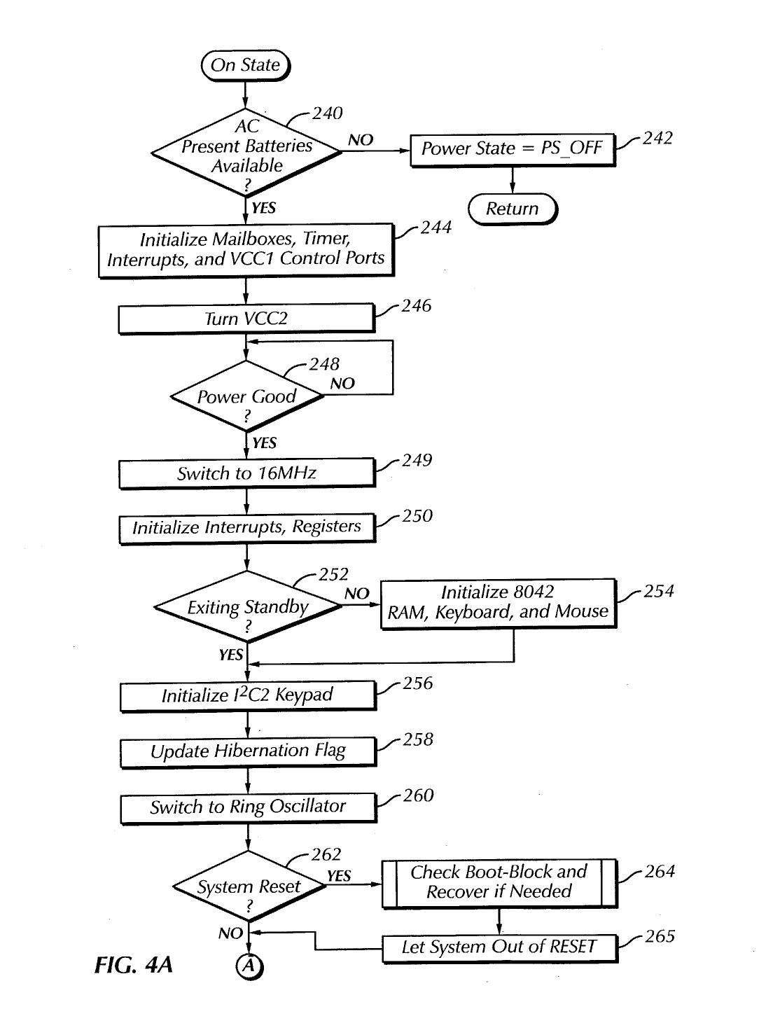

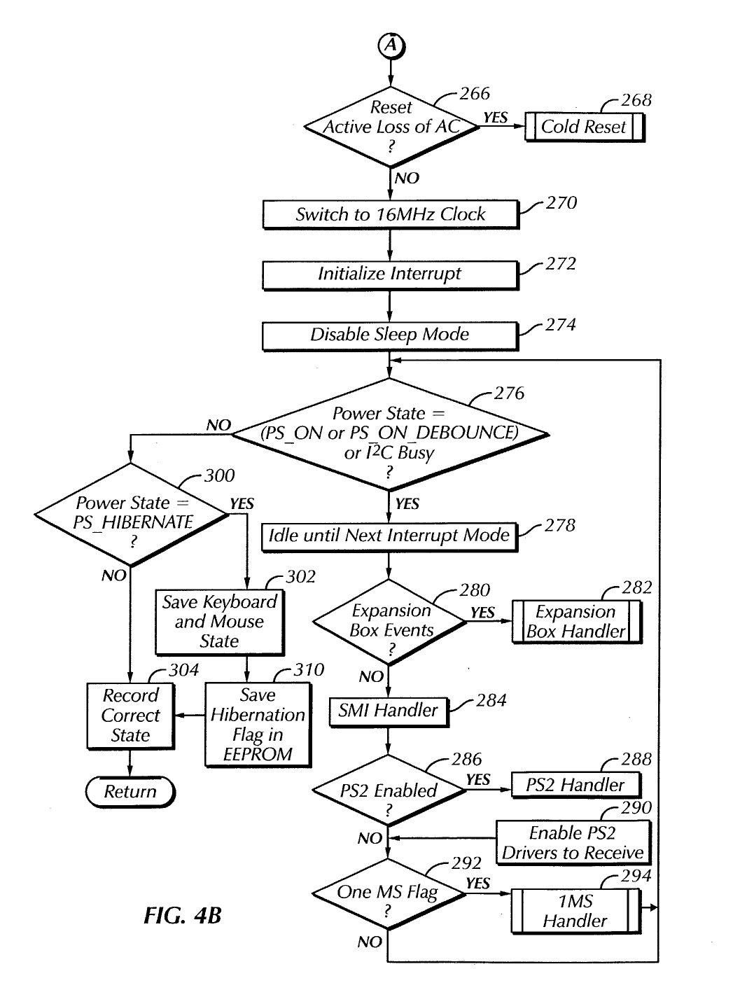

From steps 206 or step 210, the routine transitions to step 212 where the routine checks if PowerState equals PS_ON or PS_ON_DEBOUNCE. If so, the routine calls an ON state handler of FIGS. 4A and 4B in step 214. Once the ON state routine completes its execution and returns, the routine of FIG. 3 loops back to step 212 to continuously handle on, off and standby events.

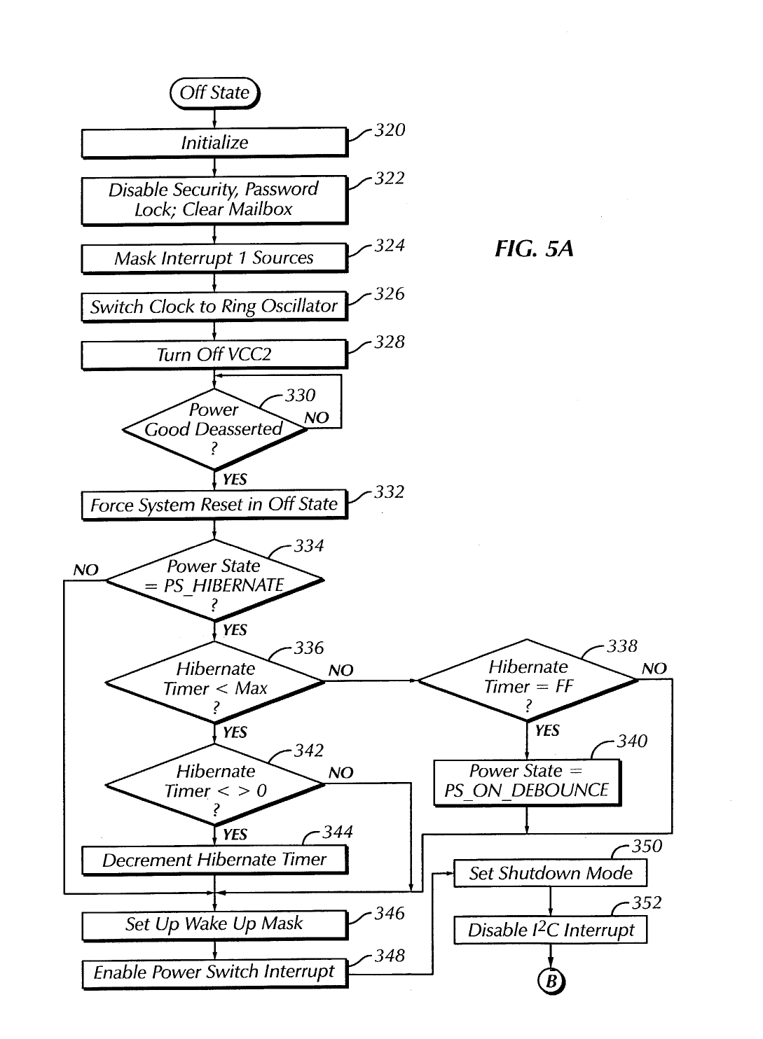

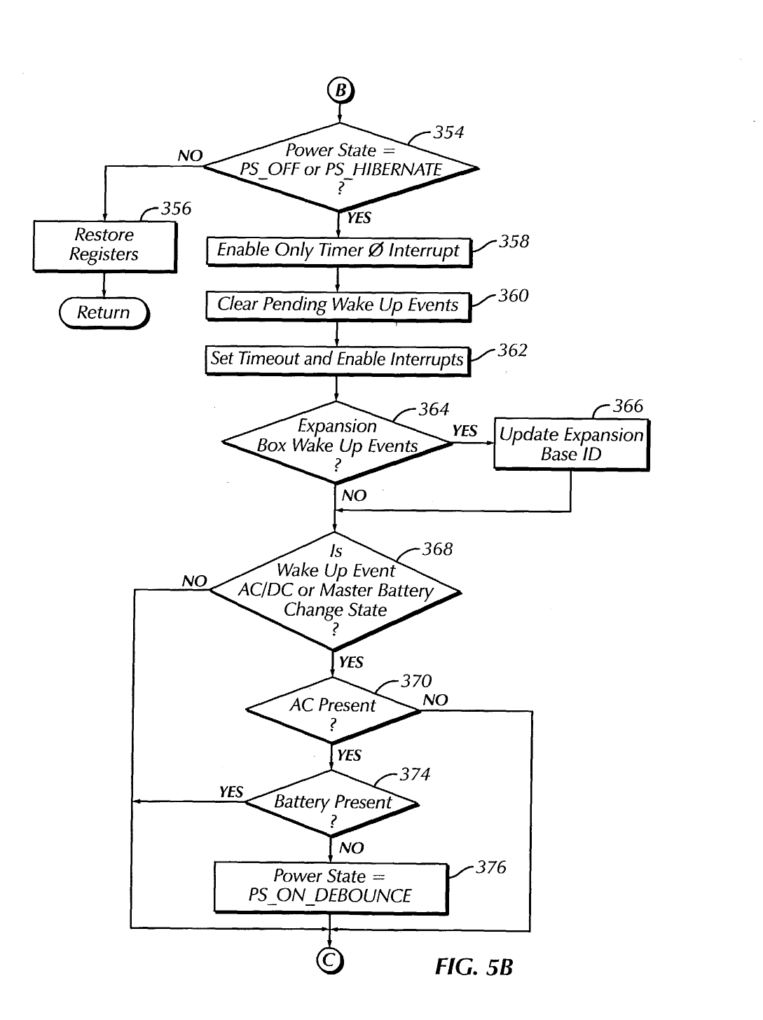

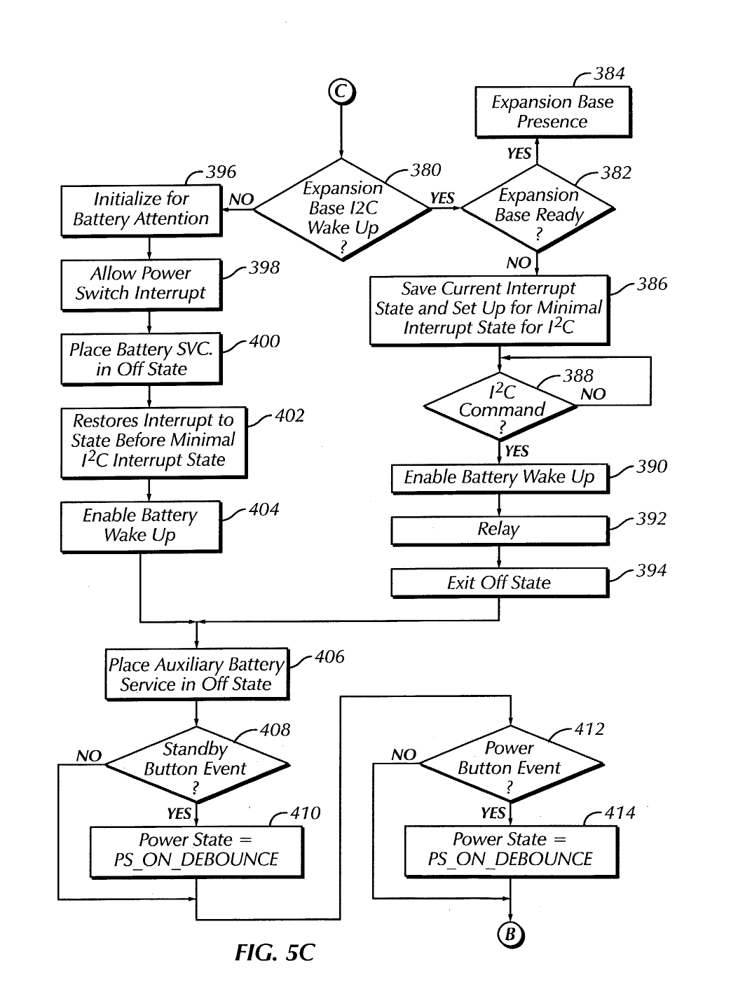

Alternatively, if PowerState is not equal to PS_ON or PS_ON_DEBOUNCE in step 212, the routine transitions to step 216 where PowerState is checked to see if it is PS_OFF or PS_HIBERNATE. If so, the routine calls an OFF state handler, which is illustrated in more detail in FIGS. 5A-5C, in step 218. Upon return from the OFF state handler of step 218, the routine returns to step 212 to continue processing on, off and standby events.

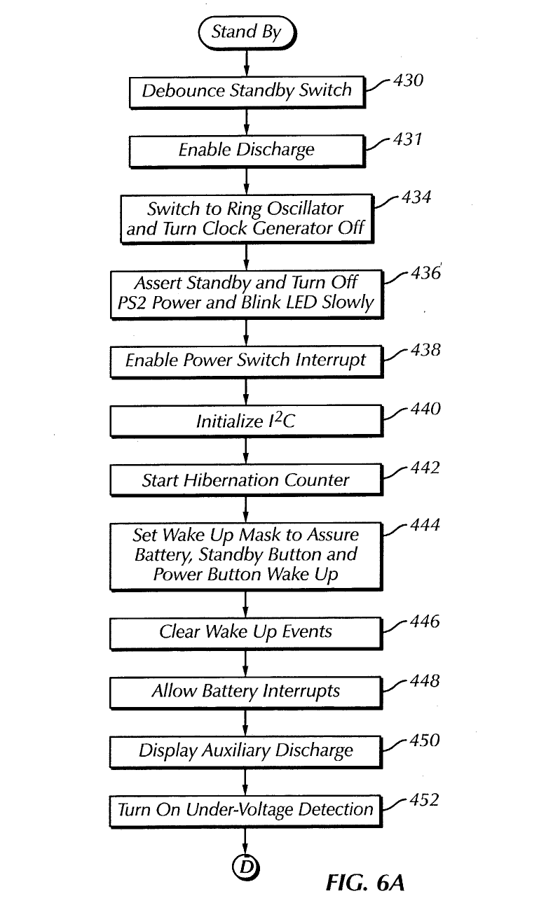

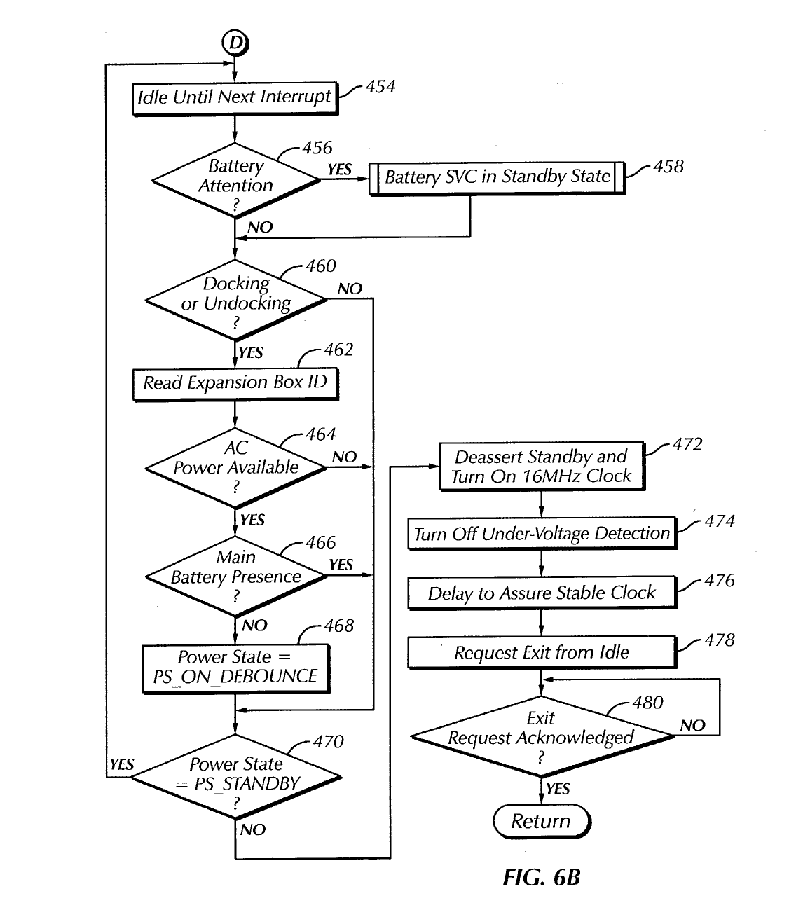

Alternatively, if PowerState is not equal to PS_OFF or PS_HIBERNATE in step 216, the routine next checks if PowerState equals PS_STANDBY in step 220. If so, the routine calls a STANDBY state handler, discussed in more detail in FIGS. 6A and 6B in step 222. Upon return from the process for handling the standby state in step 222, the routine loops back to step 212 to continue processing in an indefinite manner the on, off and standby events.

The routines to handle the ON state, OFF state and STANDBY state are discussed next. Turning now to FIGS. 4A and 4B, the routine for processing events encountered during the ON state is disclosed. In FIG. 4A, upon entry to the routine, the routine checks if AC voltage is present or the availability of a battery power source in step 240. If AC power is not present and batteries are not available in step 240, the routine assigns PS_OFF to the PowerState variable in step 242 and exits FIG. 4A by returning to the calling routine.

Alternatively, if AC power is present or batteries are available in step 240, the routine performs an initialization of the system in step 244, including an initialization of mailbox registers, timers, interrupts, and control ports associated with a VCC1 power plane. From step 244, the routine turns on the second power plane VCC2 in step 246. Next, the routine determines whether power is good in step 248. If not, the routine remains in step 248 until the power good signal is received, indicating that quality power is available.

Upon receipt of the power good indication, the routine transitions to step 249, where the 16 MHz clock becomes the source clock. Then, control proceeds to step 250 where the VCC2 control ports are initialized. Steps performed in step 250 include the steps of delaying for a predetermined period to assure a stable clock, performing the initialization of VCC2 control ports, clearing various interrupts and wake-up registers, and enabling the interrupt inputs to the microcontroller 174.

From step 250, the routine checks if the portable computer 80 is exiting the STANDBY mode in step 252. If not, the routine initializes the RAM 175 as well as the ports associated with the keyboard and/or mouse in preparation for handling keyboard activities in step 254. From step 254 or, in the event that STANDBY is being exited in step 252, the routine initializes the I²C bus and a keypad in step 256. Next, the routine updates the hibernation flag in step 258 before it switches to the ring oscillator in step 260. The hibernation flag is used to indicate whether the keyboard controller has saved the PS/2 state in EEPROM before completely removing power for absolute power conservation purposes. The ring oscillator is a low frequency, free running oscillator which is provided to minimally clock the microcontroller 174 during the low power mode.

From step 260, the routine checks to see if the system reset needs to be released in step 262. If so, the routine transitions from step 262 to step 264 where it checks the boot block of the flash ROM and performs recovery if necessary. The process for checking the boot block for performing flash ROM recovery is discussed in greater detail in co-pending patent application entitled “FLASH ROM PROGRAMMING”, previously incorporated by reference. The routine then proceeds to step 265, where the system is released from reset. From step 262 or step 265, the routine proceeds to step 266 of FIG. 4B via a connector A.

In step 266, from step 262 or 264 via the connector A, the routine of FIG. 4B checks 30 if a reset signal is active, as caused by a loss of AC power in step 266. If so, the routine transitions from step 266 to step 268 where a cold reset is performed by jumping into location 0000H of the microcontroller 174. Alternatively, if the reset signal is inactive in step 266, the routine switches the 16 MHz clock to the microcontroller 174 in step 270 to wake up the microcontroller 174. Next, in step 272, the interrupt lines are initialized by disabling interrupts, clearing pending interrupts, setting various interrupt flags, and finally enabling the interrupts once more.

Next, in step 274, the sleep mode is disabled. From step 274, the routine checks for state changes caused by various events, including battery related events. In step 276, the routine checks if PowerState equals PS_ON or PS_ON_DEBOUNCE and if the I²C bus is busy. If so, the routine is idled until the next interrupt occurs in step 278.

From step 278, the routine checks if expansion box events have been generated in step 280. If so, the routine jumps to an expansion box handler in step 282. Alternatively, if the expansion box has no events in step 280, the routine executes a system management interrupt handler in step 284 if any system management event (such as a hotkey press) is active to communicate with the processor 100 of the portable computer system 80. Next, the routine checks if the PS/2 mode is enabled in step 286. If so, the routine jumps to a PS/2 handler in step 288 and enables PS/2 devices to accept requests in step 290.. From step 290, or alternatively, if PS/2 devices are not enabled in step 286, the routine checks the one millisecond flag in step 292. If the one millisecond flag has been set, indicating that one millisecond has elapsed and that it is time to service certain devices, the routine calls a one millisecond handler in step 294.

As the name implies, the one millisecond handler of step 294 is called once each millisecond to perform timer based functions for general housekeeping functions. The routine also updates timer variables and calls other timer functions with larger granularities, such as a 50 millisecond handler, a second handler, and a minute handler. The housekeeping functions include, among others, debouncing the power switch if the PowerState equals PS_ON_DEBOUNCE. If the one millisecond flag is not set in step 292, or upon return from the one millisecond handler of step 294, the routine loops back to step 276 to continue processing of events.

From step 276, in the event that PowerState is not PS_ON or PS_ON_DEBOUNCE and the I²C bus is not busy, the routine of FIG. 4B transitions to step 300 where PowerState is further checked if it is PS HIBERNATE. If so, the routine saves the keyboard and mouse states in step 302, and then saves the hibernation flag in EEPROM. Next, the routine records the correct state in step 304. Alternatively, if PowerState is not PS_HIBERNATE, the routine proceeds directly to record the correct state in step 304. From step 304, the routine returns to the main loop of FIG. 3, step 216.

Referring now to FIGS. 5A, 5B and 5C, the routine to process events during the OFF state of the computer system of FIG. 1 is disclosed. In FIG. 5A, upon entry to the OFF state routine, variables stored in the RAM 175 as well as registers in the microcontroller 174 are initialized in step 320. Next, the routine disables the security and the password log and clears the mailbox in step 322. In step 324, the routine masks the interrupt sources and in step 326, switches the clock to the ring oscillator to allow the microcontroller 174 to enter the low power mode.

Next, the primary power plane VCC2 is turned off in step 328. The routine then waits until the power good signal is deasserted in step 330. Upon verification of the deassertion of the power good signal in step 330, the routine forces a system reset even though the portable computer system 80 is still in the OFF state in step 332. Next, in step 334, the routine checks if PowerState equals PS_HIBERNATE. If so, the routine then checks if the hibernate timer value is less than a maximum predetermined value in step 336. If not, the routine then checks if the hibernate timer value equals OFFH in step 338. If so, the routine enters step 340 from step 338 to set PowerState to PS_ON_DEBOUNCE.

In step 336, if the hibernate timer value is less than the maximum predetermined value, the routine checks if the hibernate timer value equals 0 in step 342. From step 342, if the hibernate timer value is not equal to 0, the routine decrements the hibernate timer value in step 344. If PowerState is not equal to PS_HIBERNATE in step 334, or if the hibernate timer is not equal to OFFH in step 338, or from step 344 or step 340, the routine proceeds to step 346 where it sets up the wake-up masks. Next, the routine enables the power switch interrupt in step 348 before it sets variables indicating that the portable computer system 80 is in the shutdown mode in step 350. In step 352, the routine disables the I²C interrupt before it continues with step 354 of FIG. 5B via a jumper B.

Referring now to FIG. 5B, after entering step 354 via the jumper B, the routine checks if PowerState equals PS OFF or PS_HIBERNATE. If not, the routine restores register values in step 356 before it exits FIG. 5A and 5B by returning to the caller of the OFF state routine. Alternatively, if PowerState equals PS_OFF or PS_HIBERNATE, the routine moves to step 358 where it enables only Timer_{—}0 interrupts, which is used to communicate mailbox messages, and clears all pending wake-up events in step 360. Next, in step 362, the routine sets the time out values for the counters and enables the interrupt to occur. Then, in step 364, the routine checks for expansion box wake-up events such as the insertion of the portable computer 80 into the expansion box unit 90, among others. If expansion box wake-up events exist, the routine updates the expansion base identification in step 366.

From step 366 or, in the event that no wake-up events occur in step 364, the routine proceeds to step 368 where the routine checks if wake-up events are related to AC/DC events or a master battery change state. If so, the routine proceeds to step 370 where it checks for the presence of AC power. If AC power does not exist in step 370, the routine proceeds to step 380 of FIG. 5C. Alternatively, if AC power exists in step 370, the routine checks for the presence of the battery in step 374. If the battery does not exist in step 374, the routine sets PowerState to PS_ON_DEBOUNCE in step 376. From steps 368, 372, 374 and 376, the routine proceeds to step 380 of FIG. 5C via a jumper C.

Referring now to FIG. 5C, upon entering step 380 from FIG. 5B via the connector C, the routine checks for the existence of expansion based I²C wake-up events. If these wake-up events exist, the routine checks if the expansion base 90 is ready in step 382. If so, the routine transitions to step 384 where the presence of the expansion base 90 is noted before the routine transitions to step 406.

From step 382, if the expansion base 90 is not ready, the routine initializes the I²C for operation in the OFF state in step 386 by saving the current interrupt state and setting up a minimum interrupt state for detecting I²C interrupts in step 386. From step 386, the routine checks for I²C commands in step 388. In this state, the microcontroller 174 operates in a minimal mode to conserve power. The microcontroller 174 loops in step 388 until an I²C command is received. Upon receipt of an I²C command, the routine enables the battery wake-up interrupt signal in step 390. To provide sufficient time to respond, the routine delays for a predetermined period in step 392 before it exits the OFF state in step 394 by restoring the state of the interrupt handler from the minimal state of step 386.

From step 380, in the event that the expansion based I²C wake-up events are not present, the routine transitions to step 396 where it initializes variables necessary for battery attention interrupts. Next, it allows receipt of the power switch interrupt in step 398 and places the battery service in an OFF state in step 400 in an analogous manner to that of step 386. The routine then restores the interrupt state to a state existing before the minimum I²C interrupt state of step 386. Next, the battery wake-up interrupts are enabled in step 404.

From step 394 or step 404, the routine places the auxiliary battery service in the OFF state in step 406. Next, it checks if a standby button event has been generated in step 408. If so, the routine moves to step 410 where it sets PowerState to PS_ON_DEBOUNCE. Alternatively, from step 408, in the event that the standby button has not been depressed, or from step 410, the routine checks if the power button event has been activated in step 412. If so, the routine sets the PowerState to PS_ON_DEBOUNCE in step 414. From step 414 or, in the event that the power button has not been depressed in step 412, the routine of FIG. 5C jumps to step 354 at jumper B of FIG. 5B to handle events in the OFF state until the routine returns to step 220 of FIG. 3.

Referring now to FIGS. 6A and 6B, the routine to process events in the STANDBY state is disclosed in more detail. The STANDBY state is entered when the user presses the standby button 196. In FIG. 6A, upon entry to the STANDBY routine, the standby switch is debounced in step 430. Next, in step 432, the routine enables the auxiliary battery discharge flag. In step 434, the routine switches to the ring oscillator and turns the clock generator off to conserve power in the STANDBY state. Next, the routine asserts a standby pin and turns-off the PS/2 power. Further, in step 436, the routine configures a light emitting diode (LED) to blink slowly to indicate that the system is in standby. The routine then enables the power switch interrupt in step 438 so that the user can turn on the computer system 80 from the STANDBY state.

Next, the routine initializes the I²C bus in step 440 and starts a hibernation counter in step 442. From step 442, the routine sets up the appropriate wake-up mask to assure that the interrupt associated with battery insertion/removal, the standby button and the power button wake-up events are enabled in step 444. The routine then clears all wake-up events in step 446 and allows battery related interrupts to occur in step 448. Next, the routine disables the auxiliary battery discharge flag in step 450 before it turns on the undervoltage detection mechanism in step 452 in preparing for entry into the STANDBY state. From step 452 of FIG. 6A the routine proceeds to step 454 of FIG. 6B via a jumper D.

From jumper D, the routine continues with step 454 of FIG. 6B. In step 454 of FIG. 6B, the routine idles until the next interrupt event. Upon exiting the idle mode, the routine checks for battery attention events in step 456. If such events exist, the routine jumps to the battery service in the STANDBY-state routine in step 458. From step 458 or, alternatively, if the battery 193 does not need servicing in step 456, the routine proceeds to step 460 where it checks for docking or undocking events at the expansion base unit 90. If docking or undocking events occur, the routine reads the ID of the expansion box 90 in step 462.

From step 462, the routine then checks for the availability of AC power in step 464. If AC power is available, the routine of FIG. 6B further checks for the presence of a main battery in step 466. If the main battery is not available in step 466, the routine sets PowerState to PS_ON_DEBOUNCE in step 468.

From step 468 or alternatively, from steps 460, 464 and 466, the routine proceeds to step 470 where the routine checks if the PowerState equals PS_STANDBY. If so, the routine loops back to step 454 to continue processing. Alternatively, the routine deasserts the standby mode and turns on the 16 MHz clock in step 472. Next, it turns off an undervoltage detection process to account for the finite delay between the turning on of the converter 198 in step 474. Further, the routine performs a predetermined delay to assure that the ring oscillator 187 can provide a stable clock signal in step 476. Next, the routine requests that the microcontroller 174 exits from the idle mode in step 478. The routine of FIG. 6B waits in step 480 until it receives an acknowledgment signal from the microcontroller 174. Upon receipt of the exit request acknowledgment, the routine of FIGS. 6A and 6B exits and returns to its caller.

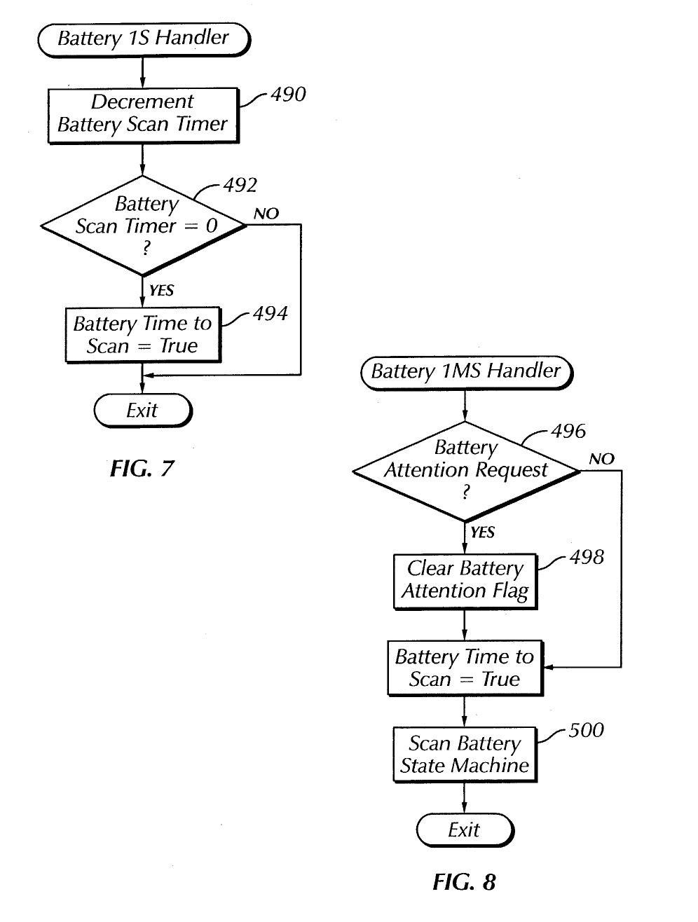

Turning now to FIG. 7, the routine to handle battery related interrupt events at each two second interval is disclosed in more detail. Preferably, the battery is scanned and then a thermal scan is performed on alternating seconds. Upon entry to the routine of FIG. 7, the routine decrements a battery scan timer counter in step 490. From step 490, the routine checks if the battery scan timer has been cleared in step 492. If so, the routine sets the battery time-to-scan flag, BatTimeToScan, to true in step 494 before it exits. Alternatively, from step 492, if the battery scan timer has not decremented to 0, the routine simply exits its checking as required on a second basis.

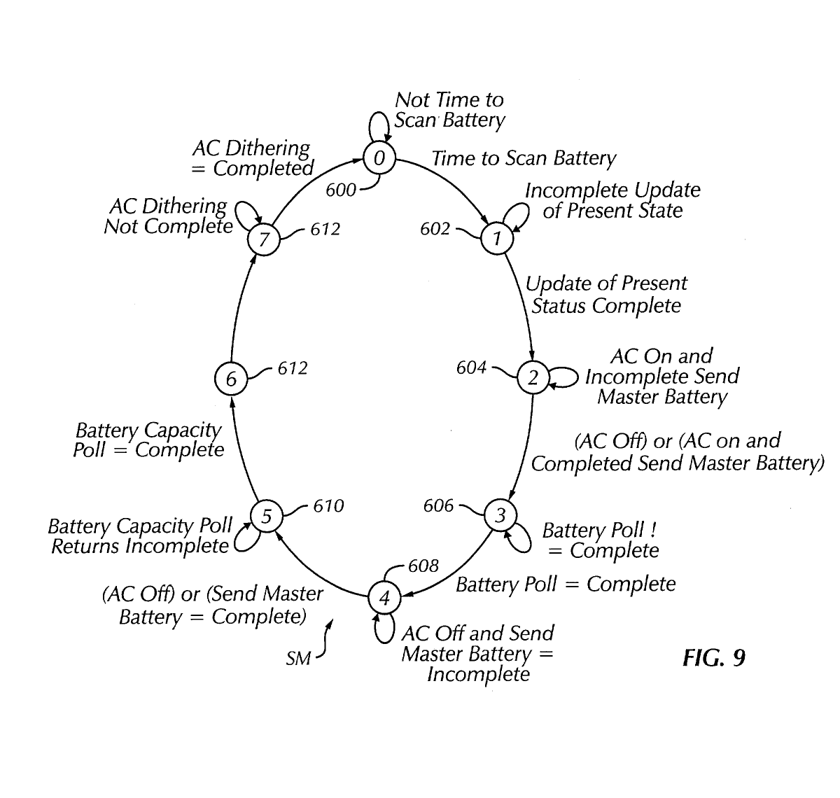

Turning now to FIG. 8, the routine to handle one millisecond interrupt events from the battery is disclosed in more detail. Upon entry to the routine of FIG. 8, the routine checks if the battery attention request flag has been asserted in step 496. If so, the routine transitions to step 498 where it clears the battery attention flag and sets the battery time-to-scan flag. Alternatively, from step 496, if the battery attention request flag has not been asserted, the routine proceeds to step 500 where it scans the battery via a state machine (SM) which is discussed in more detail in FIG. 9. Upon completion of the battery state scanning by the SM machine, the routine exits by returning to its caller.

Turning now to FIG. 9, the state machine SM for handling battery related events is disclosed. The state machine SM of FIG. 9 has eight states labeled 0 through 7 (STATE0 through STATE7). The state machine SM transitions from one state to the next, or alternatively remaining in the current state, based on certain conditions as discussed below each time the routine implementing the state machine SM is called. Although the state machine SM logically remains in the same state absent the appropriate transition conditions, it actually returns to whatever routine called it if there is no transition. That is, the state machine SM does not continually loop in each state, but returns to the calling routine until the state machine is again checked in the next one millisecond interval.

Upon reset, the state machine is in STATE0 600. The state machine will remain in STATE0 600 as long as it does not receive a signal indicating that it is time to scan the battery. Upon receipt of this signal, the state machine SM of FIG. 9 transitions from STATE0 600 to STATE1 602. The state machine SM of FIG. 9 remains in STATE1 602 as long as a routine to update the present status has not completed its operation. From STATE1 602, upon receipt of a signal from the update present status module that the status update process has been completed, the state machine SM transitions from STATE1 602 to STATE2 604. In STATE2 604, the state machine waits until either AC power is off or alternatively, that AC is on and that the send master battery routine has completed operation. If both conditions are false, the state machine SM remains in STATE2 604. Alternatively, if either AC power is off or AC power is on and the send master battery routine has completed operation, the state machine SM transitions from STATE2 604 to STATE3 606.

In STATE3 606, the routine checks if the battery poll module has completed operation. If not, the state machine SM remains in STATE3 606. Alternatively, if the battery poll module has completed operation, the state machine SM transitions from STATE3 606 to STATE4 608. In STATE4 608, the routine detects if either AC power is on or if the send master battery routine has completed operation. If neither is true, the state machine SM remains in STATE4 608. Alternatively, the state machine SM transitions to STATE5 610.

In STATE5 610, the state machine SM detects whether or not the battery capacity poll module has completed operation. If not, the state machine SM remains in STATE5. In STATE5 610, upon receipt of a signal indicating that battery capacity poll routine has completed operation, the state machine SM transitions to STATE6 612 from STATE5 610.

During the next time that the state machine SM is called, the state machine SM simply transitions from STATE6 612 to STATE7 614. STATE6 612 thus unconditionally transitions from STATE6 612 to STATE7 614. While the state machine is in STATE6 612, it nonetheless performs various mailbox communications before checking for the completion of the AC dithering operation which allows the voltage to be more precisely regulated at the battery pack level and to overcome errors associated with the battery series resistance problem. The dithering process is discussed in more detail in a co-pending, commonly assigned application entitled “INTERACTIVE AC ADAPTER OUTPUT VOLTAGE”, hereby incorporated by reference.

In STATE7 614, the state machine SM checks if the AC dithering operation has completed operation. If not, the state machine SM remains in STATE7 614. Alternatively, if the AC dithering operation has completed, the state machine SM transitions back to STATE0 600, where the state machine SM is ready to perform the next scan battery operation once again.

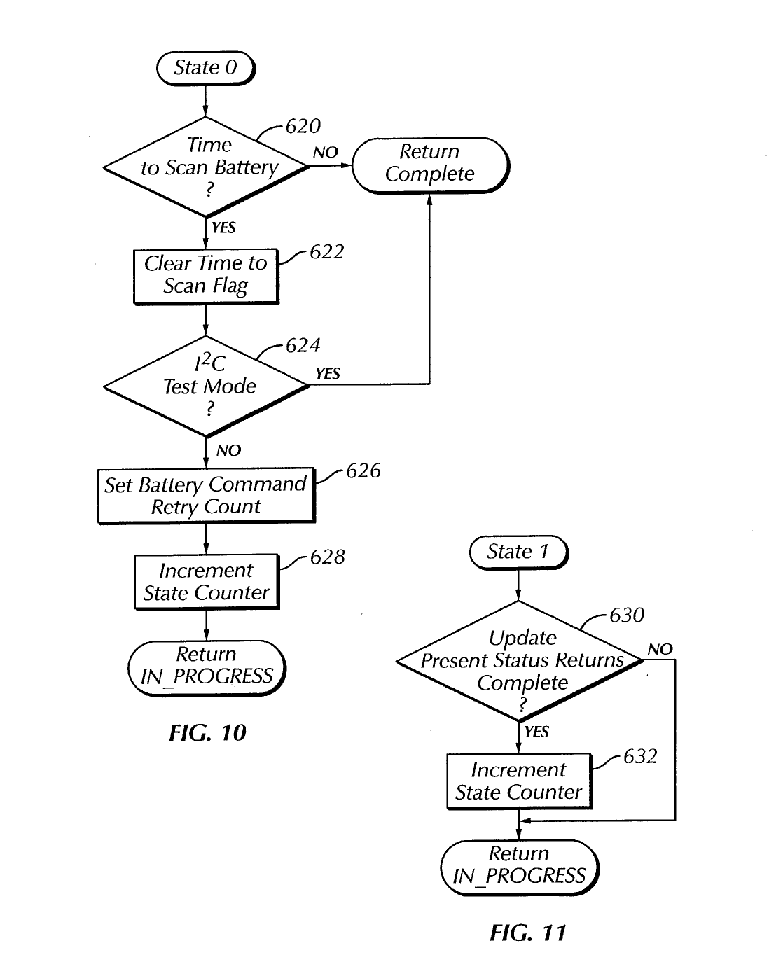

Referring now to FIG. 10, the process for handling STATE0 of 600 of FIG. 9 is shown. Upon entry to the routine of FIG. 10, the routine checks if it is time to scan the battery in step 620. If not, the routine simply returns with an indication that it has completed operation. Alternatively, from step 620, if it is time to scan the battery, the routine transitions to step 622 where it clears the time-to-scan flag. Next, the routine checks in step 624 whether or not the I²C test mode is active. If the system is in the I²C test mode, the routine simply exits with an indication that it has completed operation from step 624. Alternatively, if the I²C test mode is inactive, the routine sets the battery command retry count in step 626. Next, the routine of FIG. 10 increments a state counter tracking the states of the state machine SM of FIG. 9 in step 628 before it returns with a flag indicating that it is still in progress.

Turning now to FIG. 11, the routine to handle events in STATE1 602 is disclosed. Upon entry to the routine of FIG. 11, the routine checks whether or not the update present status module has completed operation in step 630. If not, the routine simply returns with a flag indicating that the update status routine is in progress. Alternatively, if the update present status module has completed operation, the routine increments the state counter in step 632 before it returns with an indication that it is still in progress.

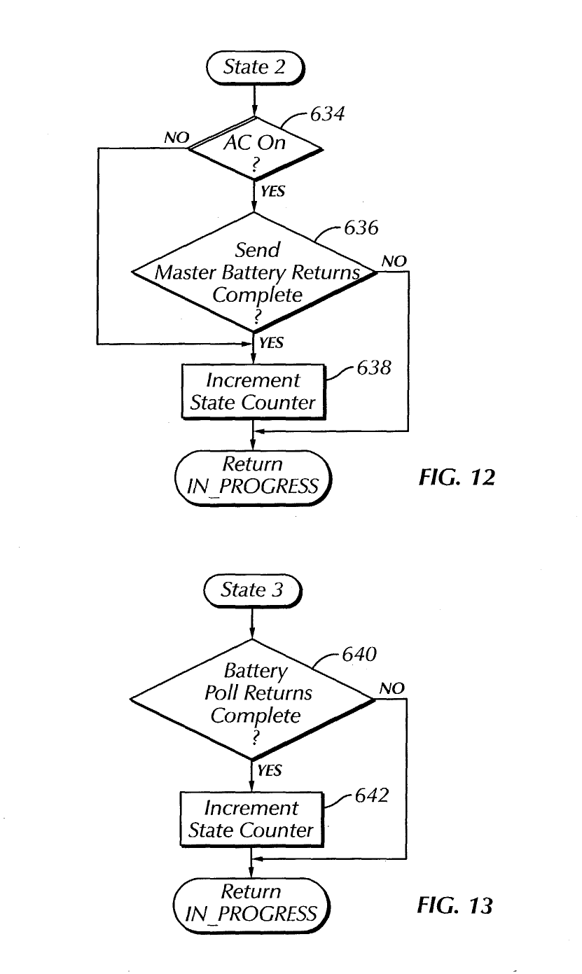

Referring now to FIG. 12, the routine for handling events in STATE2 604 is shown. 30 in FIG. 12, the routine checks if the AC power is on in step 634. If so, the routine further checks if the send master battery module has completed operation in step 636. If the send master battery module has completed operation, the routine transfers to step 638 where it increments the state counter before it returns with an indication that it is still in progress. From step 634, if AC power is off, the routine transitions to step 638 to increment the state counter. Further, from step 636, if the send master battery module has not completed operation, the routine of FIG. 12 skips the state counter increment step and simply returns with an in-progress indication.

In FIG. 13, the routine to handle events in STATE3 606 is discussed. In STATE3 606, the routine checks whether the battery poll module has completed operation in step 640. If not, the routine of FIG. 13 simply returns with an indication of in-progress. Alternatively, if the battery poll module has completed operation, the routine increments the state counter in step 642 before it returns with an in-progress indication.

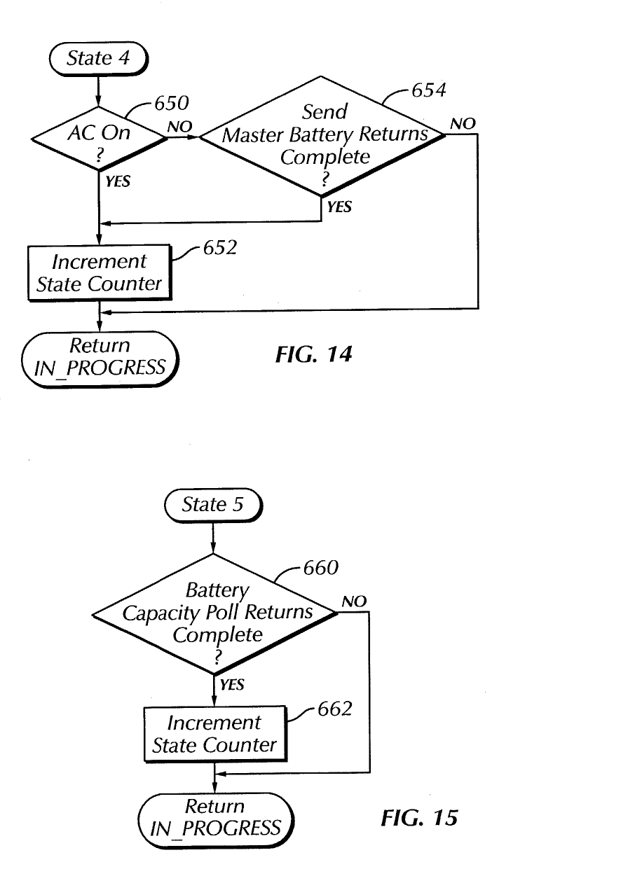

Turning now to FIG. 14, the routine to handle events in STATE4 608 is shown. In FIG. 14, the routine checks if AC power is on in step 650. In the event that AC power is off, the routine further checks if the send master battery module has completed operation in step 654. If not, the routine simply returns with an indication that it is in progress.

From step 650, if AC is off, or from step 654, if the send master battery module has completed operation, the routine of FIG. 14 transitions to step 652 where it increments the state counter before it returns with an indication of in-progress.

Referring now to FIG. 15, the routine for handling events in STATE5 610 is discussed in more detail. In FIG. 15, the routine first checks if the battery capacity poll module has completed operation in step 660. If not, the routine simply returns with an indication of in-progress. Alternatively, the routine simply increments the state counter in step 662 if the battery capacity poll module has completed operation and returns with an indication of in-progress.

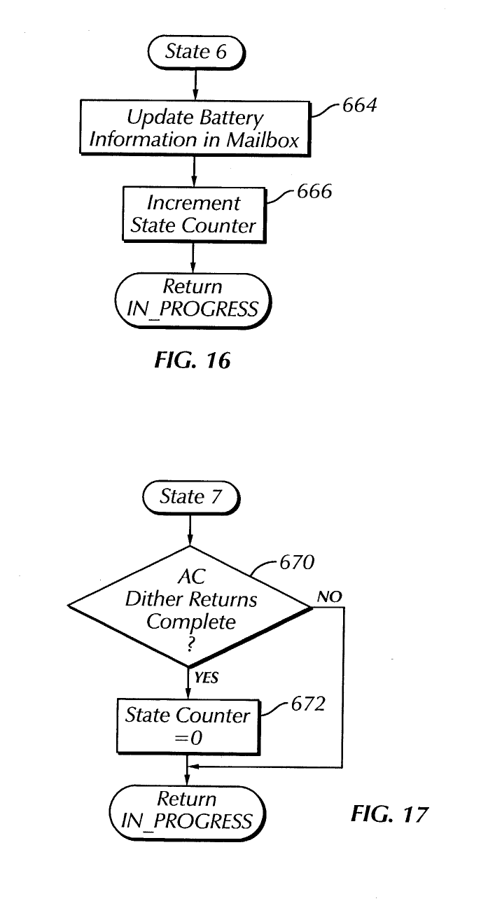

Turning now to FIG. 16, the routine for processing events of STATE6 612 is shown. In FIG. 16, upon entry to STATE6 612, the routine updates battery information via mailbox registers in step 664. It then increments the state counter in step 666 such that the state machine SM transitions from STATE6 to STATE7. Next, the routine returns with an indication of in-progress.

Referring now to FIG. 17, the routine to process events in STATE7 614 is shown in more detail. In STATE7, the routine first checks if the AC dithering module has completed operation in step 670. If not, the routine returns with an in-progress indication. Alternatively, if the AC dithering operation has completed, the routine of FIG. 17 clears the state counter to zero in step 672 before it returns with an in-progress indication. Thus, when the state machine SM is next invoked, the state machine SM starts off with STATE0 600.

The thus disclosed microcontroller 174 communicates with the input/output device and receives battery status events from the battery, the power on button, the standby button, as well as other inputs. During normal processing, the microcontroller receives input from the keyboard and forwards the keyboard data to the processor. The microcontroller also periodically polls the battery packs in seriatim. The batteries are polled to detect battery charge, discharge, and battery removal status information such that these information can be relayed to a user by the processor upon query. To minimize power consumption and to preserve battery operating life, power is removed from most sub-systems of the computer system, with the exception of the microcontroller. The microcontroller is placed in the deep sleep mode where it is clocked at a nominally slow frequency by a ring oscillator to minimize power consumption. When the battery sends status signals to the microcontroller, the microcontroller is waken. The microcontroller then polls the battery and updates the battery information. Upon completing the battery polling and information update process, the microcontroller is placed once more in the deep sleep mode to conserve battery power.

The foregoing disclosure and description of the invention are illustrative and explanatory thereof, and various changes in the size, shape, materials, components, circuit elements, wiring connections and contacts, as well as in the details of the illustrated circuitry and construction and method of operation may be made without departing from the spirit of the invention.

We claim:

1. A portable computer system, comprising:
a processor;
a keyboard;
a direct current/direct current converter; and
a keyboard controller coupled to the processor, the keyboard, and the direct current/direct current converter, the keyboard controller comprising:
a means for receiving data from the keyboard;
a means for turning on power to the direct current/direct current converter; and
a means for turning off the power to the direct current/direct current converter.

2. The computer system of claim 1, wherein the keyboard controller is directly connected to the direct current/direct current converter.

3. The computer system of claim 1, wherein the keyboard controller drives a power enable signal to the direct current/direct current converter.

4. The computer system of claim 1, the computer system including a battery, the keyboard controller further comprising:
a means for polling the battery for battery status information.

5. The computer system of claim 4, wherein the battery is directly connected to the keyboard controller.

6. The computer system of claim 1, the means for turning on power to the direct current/direct current converter comprising:
a means for turning on the power to the direct current/direct current converter in response to user activation of a power button of the portable computer system.

7. The computer system of claim 1, the means for turning on power to the direct current/direct current converter comprising:
a means for turning on the power to the direct current/direct current converter in response to sensing a lid of the portable computer system as in an open state.

8. The computer system of claim 1, the keyboard controller further comprising:
a means for testing the direct current/direct current converter to determine if alternating current power is present.

9. The computer system of claim 1, wherein the keyboard controller is powered during a low-power mode of the portable computer system.

10. The computer system of claim 1, wherein the keyboard controller is integrated into a super input/output chip.

11. The computer system of claim 1, wherein the keyboard controller comprises a microcontroller.

12. A power management apparatus for a portable computer system, the portable computer system including a processor, a keyboard, and a direct current/direct current converter, the apparatus comprising:
a keyboard controller to receive data from the keyboard and to control powering of the direct current/direct current converter.

13. The power management apparatus of claim 12, further comprising:
a power enable signal line provided by the keyboard controller to the direct current/direct current converter.

14. The power management apparatus of claim 12, further comprising:
a battery status signal line provided to the keyboard controller from a battery of the portable computer system.

15. The power management apparatus of claim 12, further comprising:
a power signal line provided to the keyboard controller to indicate a state of a power button of the portable computer system.

16. The power management apparatus of claim 12, further comprising:
a lid open signal line provided to the keyboard controller to indicate an open state of a lid of the portable computer system.

17. The power management apparatus of claim 12, wherein the keyboard controller is powered during a low-power mode of the portable computer system.

18. The power management apparatus of claim 12, wherein the keyboard controller comprises a microcontroller.

19. A computer system, comprising:
a processor;
a keyboard;
a direct current/direct current converter; and
a controller coupled to the processor, the keyboard, and the direct current/direct current converter, the controller being adapted to receive data from the keyboard and to control powering of the direct current/direct current converter.

20. The computer system of claim 19, wherein the controller drives a power enable signal to the direct current/direct current converter.

21. The computer system of claim 19, wherein the controller polls a battery of the portable computer system for battery status information.

22. The computer system of claim 19, wherein the controller is powered during a low-power mode of the portable computer system.

23. The computer system of claim 19, wherein the controller comprises a keyboard controller.

24. A method of handling power management control with a keyboard controller of a portable computer system, the portable computer system including a keyboard and a direct current/direct current converter, the method comprising the steps of:
receiving keyboard events from the keyboard by the keyboard controller; and
controlling power to the direct current/direct current converter by the keyboard controller.

25. The method of claim 24, the computer system including a battery, the method further comprising the step of:
receiving battery status events from the battery by the keyboard controller.

26. The method of claim 24, the controlling step comprising the step of:
turning on the power to the direct current/direct current converter by the keyboard controller in response to user activation of a power button of the computer system.
